(19) United States
(12) Patent Application Publication
(10) Pub. No.: US 2013/0346871 A1
(43) Pub. Date: Dec. 26, 2013

(54) GRAPHICAL USER INTERFACE APPARATUS, SYSTEM, METHOD AND COMPUTER PROGRAM PRODUCT

(71) Applicant: BUFFALO INC., Nagoya-shi (JP)

(72) Inventor: Akira ONO, Nagoya-shi (JP)

(21) Appl. No.: 13/920,461

(22) Filed: Jun. 18, 2013

(30) Foreign Application Priority Data
Jun. 25, 2012 (JP) 2012-142026A

(51) Int. Cl. H04L 12/24

(52) U.S. Cl. CPC H04L 41/22
USPC 715/736

(57) ABSTRACT

A graphical user interface apparatus with a display unit is provided. The graphical user interface apparatus displays a taken image including a wireless communication device with an antenna, in correlation to an antenna characteristic image representing an antenna characteristic including at least one of a directionality of a radio wave radiated from the antenna and a direction of polarization of the radio wave radiated from the antenna, on the display unit. This configuration facilitates adjustment of the direction of the antenna included in the wireless communication device.

### CROSS-REFERENCE TO RELATED APPLICATIONS

This application claims priority under 35 U.S.C. §119 to Japanese Patent Application No. 2012-142026A filed on Jun. 25, 2012, which is hereby incorporated by reference in its entirety and for all purposes.

### BACKGROUND

1. Field of the Invention

The present disclosure relates to a technique of adjusting an antenna of a wireless communication device.

2. Description of the Related Art

A wireless LAN (Local Area Network) access point or a wireless LAN station has an antenna used for receiving and sending radio waves and enables wireless communication using the antenna. The station is not limited to a stand-alone device may be, for example, a wireless LAN adapter attached to a personal computer. Various adjustments including adjustment of the direction of the antenna are generally performed in the access point or the station, for the purpose of improving the communication quality between the access point and the station. In order to support such adjustment of the direction of the antenna, a system of displaying the reception level of radio signal or displaying a message representing the signal reception status has been proposed, for example, like the technology described in JP 2005-303477A.

This system displays the reception level of radio signal or the message representing the signal reception status, but the information such as the signal reception level does not inform the user of how the direction of the antenna is to be adjusted for the more favorable communication quality. The user is thus required to determine the direction of the antenna by trial and error and has the significant work load.

Such problem is especially significant in the applications using a plurality of antennas, such as MIMO technology. This problem is not limited to the access point or the station but may also occur in any wireless communication device that has an antenna and is connected to a wireless LAN, such as WDS (Wireless Distribution System).

### SUMMARY

In order to solve at least part of the foregoing problems, the disclosure may be implemented by aspects or embodiments described above.

According to a first aspect of the disclosure, there is provided a graphical user interface apparatus including a display unit and a display controller. The display controller may be configured to display a taken image including a wireless communication device with an antenna, in correlation to an antenna characteristic image representing an antenna characteristic including at least one of a directionality of a radio wave radiated from the antenna and a direction of polarization of the radio wave radiated from the antenna, on the display unit. The graphical user interface apparatus of this aspect displays the antenna characteristic image representing the antenna characteristic in correlation to the taken image including the wireless communication device and thereby facilitates the user's understanding on the more favorable direction of the antenna. This also facilitates the user's adjustment of the direction of the antenna included in the wireless communication device. The “taken image” herein is not limited to still image but is used in a wider sense including moving image (video). The “taken image” of this aspect is also not limited to the actually taken image itself but includes an image obtained by image processing, such as binarization or contour enhancement, on the actually taken image. Additionally, the “taken image” of this aspect also includes a computer graphic image created based on the actually taken image and a composite image of the computer graphic image and the actually taken image.

According to a second aspect, there is provided a system including a first device and a second device connected with the first device via a network and being arranged to support adjustment of direction of an antenna included in a wireless communication device. In this system, the first device may include: an imaging unit that obtains a taken image including the wireless communication device; a taken image sender that sends the taken image to the second device; and a display unit that displays an image received from the second device. The second device may include: a type identifier that identifies a type of the wireless communication device, based on the taken image received from the first device; an antenna characteristic information acquirer that acquires antenna characteristic information regarding an antenna characteristic including at least one of a directionality of a radio wave radiated from the antenna and a direction of polarization of the radio wave radiated from the antenna, based on the identified type; an antenna characteristic image creator that creates an antenna characteristic image representing the antenna characteristic, based on the obtained antenna characteristic information; an image composer that combines the taken image with the antenna characteristic image and thereby create a composite image; and a composite image sender that sends the composite image to the first device. This system displays the antenna characteristic image representing the antenna characteristic in correlation to the taken image including the wireless communication device. Such display facilitates the user's understanding on the more favorable direction of the antenna. This also facilitates the user's adjustment of the direction of the antenna included in the wireless communication device. Additionally, this system does not require the first device to perform the processes of identifying the type of the wireless communication device, obtaining the antenna characteristic information, creating the antenna characteristic image and creating the composite image, thus reducing the processing load of the first device. This reduces the required storage capacity and the required processing capacity of the first device to the relatively low levels and thereby reduces the manufacturing cost of the first device. The first device may, however, be configured to perform part of all of the above processes, for example, the process of identifying the type of the wireless communication device and the process of obtaining the antenna characteristic information.

According to a third aspect, there is provided a method of supporting adjustment of direction of an antenna included in a wireless communication device by using a graphical user interface apparatus with a display unit. The method may include obtaining a taken image including the wireless communication device in the graphical user interface apparatus; and displaying an antenna characteristic image representing an antenna characteristic including at least one of a directionality of a radio wave radiated from the antenna and a direction of polarization of the radio wave radiated from the antenna, in correlation to the taken image, on the display unit. This method displays the antenna characteristic image representing the antenna characteristics in correlation to the taken image including the wireless communication device. This facilitates the user's understanding on the more favorable direction of the antenna. This also facilitates the user's adjustment of the direction of the antenna included in the wireless communication device.

According to a fourth aspect, there is provided a method of supporting adjustment of direction of an antenna included in a wireless communication device by using a system that includes a first device with a display unit and a second device connected with the first device via a network. The method may include obtaining a taken image including the wireless communication device in the first device; sending the taken image from the first device to the second device; identifying a type of the wireless communication device in the second device, based on the taken image received from the first device; acquiring antenna characteristic information regarding an antenna characteristic including at least one of a directionality of a radio wave radiated from the antenna and a direction of polarization of the radio wave radiated from the antenna in the second device, based on the identified type; creating an antenna characteristic image representing the antenna characteristic in the second device, based on the obtained antenna characteristic information; combining the taken image with the antenna characteristic image to create a composite image in the second device; sending the created composite image from the second device to the first device; and displaying the composite image received from the second device on the display unit in the first device. This method displays the antenna characteristic image representing the antenna characteristic, in correlation to the taken image including the wireless communication device. Such display facilitates the user's understanding on the more favorable direction of the antenna. Such display also facilitates the user's adjustment of the direction of the antenna included in the wireless communication device. Additionally, this method does not necessarily require the first device to perform the processes of identifying the type of the wireless communication device, obtaining the antenna characteristic information, creating the antenna characteristic image and creating the composite image, thus reducing the processing load of the first device. This reduces the required storage capacity and the required processing capacity of the first device to the relatively low levels and thereby reduces the manufacturing cost of the first device. The first device may, however, be configured to perform part of all of the above processes.

According to a fourth aspect, there is provided a computer program product for supporting adjustment of direction of an antenna included in a wireless communication device by using a graphical user interface apparatus with a display unit. The computer program product may include: a first program code of causing the graphical user interface apparatus to obtain a taken image including the wireless communication device; and a second program code of causing the graphical user interface apparatus to display an antenna characteristic image representing an antenna characteristic including at least one of a directionality of a radio wave radiated from the antenna and a direction of polarization of the radio wave radiated from the antenna, in correlation to the taken image on the display unit. The computer readable instructions are executed to display the antenna characteristic image representing the antenna characteristic, in correlation to the taken image including the wireless communication device. This facilitates the user's understanding on the more favorable direction of the antenna. This also facilitates the user's adjustment of the direction of the antenna included in the wireless communication device.

The disclosure may be implemented by any of various aspects and applications without departing from the scope of the disclosure: for example, a mobile phone terminal, a digital still camera, control methods of these devices, a non-transitory computer storage medium in which computer readable instructions that enable the functions of these devices.

### BRIEF DESCRIPTION OF THE DRAWINGS

FIG. 1 is a diagram illustrating the schematic configuration of a system including a mobile phone terminal as one embodiment of the graphical user interface apparatus of the disclosure;

FIG. 2 is a block diagram illustrating the detailed structure of the mobile phone terminal 100 shown in FIG. 1;

FIG. 3 is a diagram illustrating the settings of the antenna characteristic information database stored in the antenna characteristic information database storage 20a;

FIG. 4 is a diagram illustrating the installation locations of antennas;

FIG. 5 is a diagram schematically illustrating the display positions in the guide information;

FIG. 6 is a flowchart showing the procedure of the antenna characteristic guide process according to the first embodiment;

FIG. 7 is a diagram illustrating one example of the composite image displayed at step S125;

FIG. 8 is a diagram illustrating the schematic configuration of an antenna adjustment support system according to a second embodiment;

FIG. 9 is a block diagram illustrating the detailed structure of the mobile phone terminal 100a according to the second embodiment;

FIG. 10 is a block diagram illustrating the detailed structure of the server 500 shown in FIG. 8;

FIG. 11 is a sequence diagram showing the procedure of the antenna characteristic guide process according to the second embodiment;

FIG. 12 is a flowchart showing the procedure of an antenna characteristic guide process according to the third embodiment;

FIG. 13 is a diagram illustrating one example of the composite image displayed at step S125 according to the third embodiment;

FIG. 14 is a flowchart showing the procedure of an antenna characteristic guide process according to the fourth embodiment;

FIG. 15 is a diagram illustrating one example of the composite image displayed at step S125 according to the fourth embodiment;

FIG. 16 is a diagram illustrating one example of the composite image in the Modification 1;

FIG. 17 is a diagram illustrating one example of the composite image in the Modification 1; and

FIG. 18 is a diagram illustrating one example of the composite image in the Modification 2.

### DETAILED DESCRIPTION

### A. First Embodiment

A1. Device Configuration

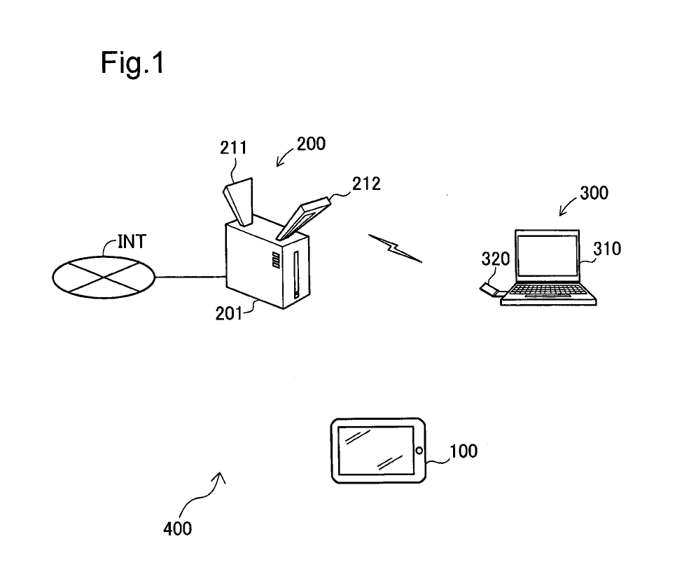

FIG. 1 is a diagram illustrating the schematic configuration of a system including a mobile phone terminal as one embodiment of the graphical user interface apparatus of the disclosure. The system 400 includes a router 200, a client 300 and a mobile phone terminal 100. The router 200 is connected through an access line such as ADSL (Asymmetric Digital Subscriber Line) to a wide-area LAN, such as the Internet INT. The router 200 serves as a wireless LAN (Local Area Network) access point to establish wireless communication with the client 300. The router 200 includes a main unit 201 and two antennas 211 and 212. The two antennas 211 and 212 are disposed on the upper surface of an enclosure of the main unit 201 in such a manner as to allow attitudinal change.

The client 300 includes a personal computer 310 and a station 320 (wireless handset) 320. The personal computer 310 employs USB (Universal Serial Bus) as the interface for mounting the station 320. The interface employed for mounting the station 320 is not limited to USB but may be any of various interfaces, such as PCI bus, IEEE1394, ExpressCard, and eSATA. In the personal computer 310, an application works to establish communication with another device via the Internet INT. One typical example of such application is an application to download images from a WWW (World Wide Web) server. The station 320 includes a modulator, an amplifier and an antenna and serves as a wireless LAN client to establish wireless communication with the router 200. The wireless LAN which the router 200 and the client 300 (station 320) belong to may be a wireless LAN conforming to, for example, IEEE802.11a/b/g/m. Alternatively another wireless system such as Blue Tooth or wireless USB may be employed.

The mobile phone terminal 100 performs an antenna characteristic guide process described later to display the antenna characteristics of the antennas 211 and 212. Such display informs the user of which directions the antennas 211 and 212 of the router 200 are to be adjusted in order to improve the quality of wireless communication between the router 200 and the client 300. The “antenna characteristics” according to the embodiment include directional angle (i.e., angle indicating a directional range having the intensity of radiation equal to or greater than a specified value) and direction of polarization (direction of polarization plane). The smaller difference between the direction of polarization of the antennas 211 and 212 of the router 200 and the direction of polarization of the antenna of the client 300 (station 320) increases the received signal strength and thereby improves the communication quality. The smaller difference between the directionality of the antennas 211 and 212 of the router 200 and the directionality of the antenna of the client 300 (station 320) also increases the received signal strength and thereby improves the communication quality.

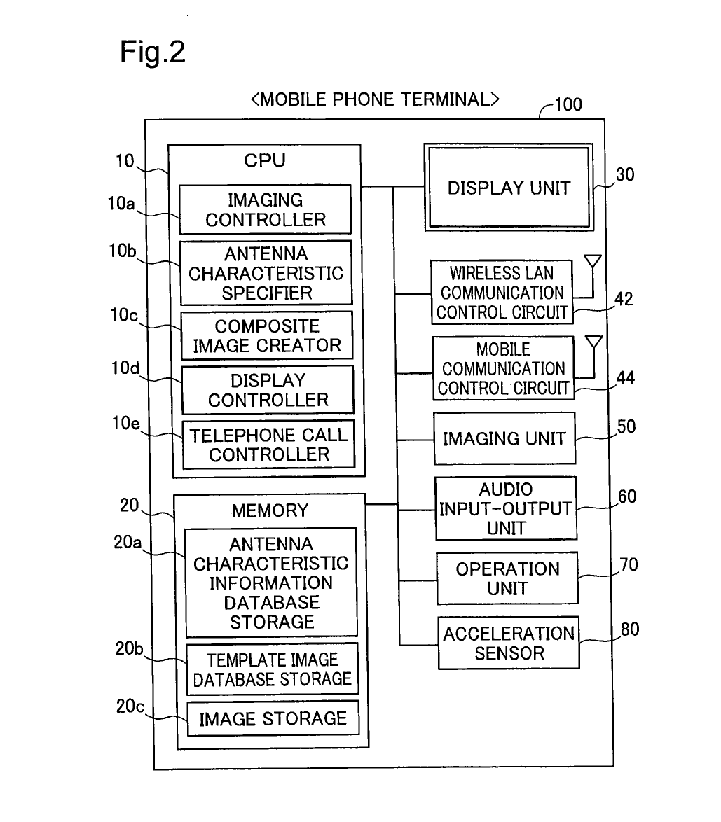

FIG. 2 is a block diagram illustrating the detailed structure of the mobile phone terminal 100 shown in FIG. 1. The mobile phone terminal 100 includes a display unit 30, a wireless LAN communication control circuit 42, a mobile communication control circuit 44, an imaging unit 50, an audio input-output unit 60, an operation unit 70, an accelerations sensor 80, a CPU (Central Processing Unit) 10 for controlling these components and a memory 20.

The display unit 30 is implemented by a touch panel display to display, for example, taken images and various menu screens and output information regarding the contact state of, for example, a touch pen or a finger. The wireless LAN communication control circuit 42 includes a modulator, an amplifier and an antenna and serves as a wireless LAN client conforming to, for example, IEEE802.11a/b/g/n to establish wireless communication with a wireless LAN access point. The mobile communication control circuit 44 includes a modulator, an amplifier and an antenna and serves as a mobile communication terminal conforming to, for example, 3G/HSPA (High Speed Packet Access) to establish wireless communication with a base station of a mobile communication network. The imaging unit 50 includes an imaging element such as CCD (Charge Coupled Device) and optical lenses and works to take an image of an object and obtain image data. The audio input-output unit 60 includes a microphone and a speaker and works to input and output sound and voice. The operation unit 70 includes operation buttons for selecting various menus, operation buttons for adjusting the volume, buttons for entering numbers and character strings, and a shutter button.

The CPU 10 executes a control program stored in the memory 20 to serve as an imaging controller 10a, an antenna characteristic specifier 10b, a composite image creator 10c, a display controller 10d and a telephone call controller 10e.

The imaging controller 10a controls the imaging unit 50 according to imaging parameters (e.g., aperture, lightness and number of shots) input from the operation unit 70 and the display unit 30 to obtain image data and store the obtained image data into the memory 20. The antenna characteristic specifier 10b identifies the model number of a target device and specifies the characteristics of an antenna included in the target device in the antenna characteristic guide process described later. The composite image creator 10c creates an image (computer graphics) representing the antenna characteristics and combines the image representing the antenna characteristics with an image obtained by the imaging unit 50 to create a composite image in the antenna characteristic guide process described later. The display controller 10d causes images and various menu screens to be displayed on the display unit 30 and processes information from the touch panel. More specifically, when the user contacts the surface of the display unit 30 with, for example, a finger or a touch pen, the display controller 10d receives information on the contact state output from the display unit 30 and specifies the user's selected menu or the user's entered character string, based on the images displayed on the display unit 30 and the position of the contact. The telephone call controller 10e controls calls.

The memory 20 includes an antenna characteristic information database storage 20a, a template image database storage 20b and an image storage 20c. The antenna characteristic information database storage 20a has an antenna characteristic information database stored in advance. The template image database storage 20b stores template images, and the image storage 20c stores taken images and composite images. These images will be described later in detail.

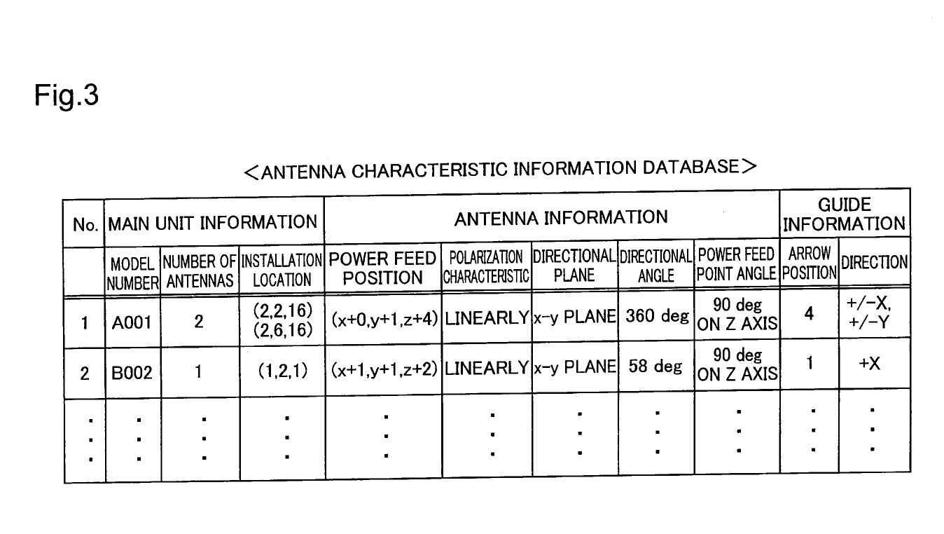

FIG. 3 is a diagram illustrating the settings of the antenna characteristic information database stored in the antenna characteristic information database storage 20a. The antenna characteristic information database includes main unit information, antenna information and guide information set in advance with respect to various access points and stations. The main unit information includes the model number of each access point or each station, the number of antennas included in each access point or each station, and the installation location of each antenna. Such information may be stored in advance in the memory 20 as data attached to an application for performing the antenna characteristic guide process or may be read from an external storage device such as an SD memory card as needed basis. Alternatively such information may be obtained by taking an image of, for example, a QR code.

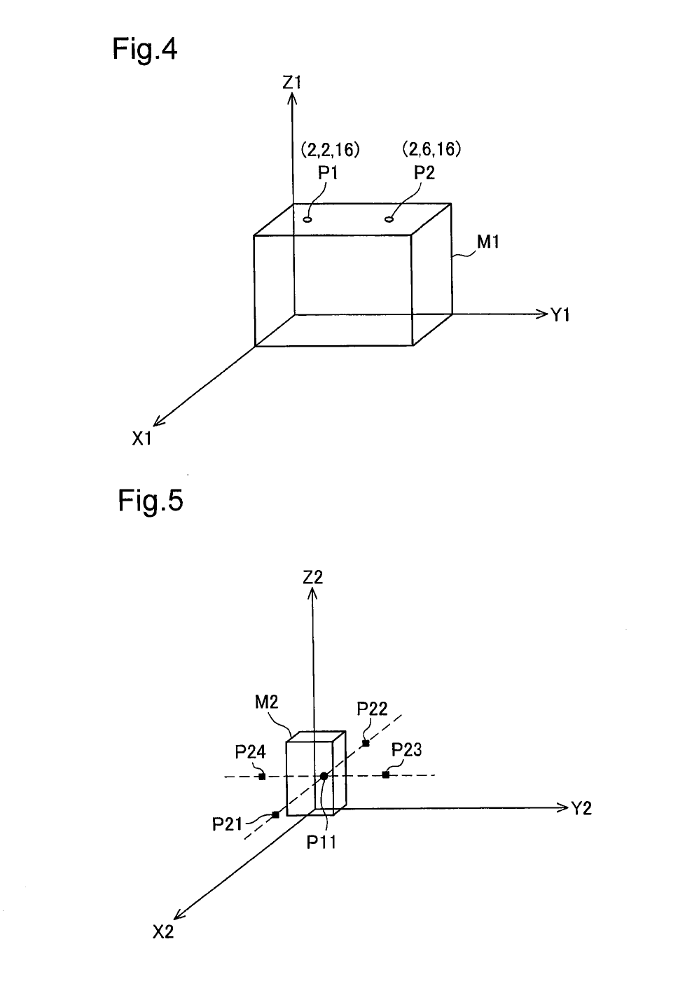

FIG. 4 is a diagram illustrating the installation locations of antennas. As one example, FIG. 4 shows the installation locations of antennas included in an access point of the model number “A001”. The access point of the model number “A001” is the same type of the device as the router 200 shown in FIG. 1. The main unit of each access point is simulated, and the installation location of each antenna in the simulated main unit is set in advance in the antenna characteristic information database. For example, the main unit of the access point of the model number “A001” is simulated as a model M1 as shown in FIG. 4, and the installation locations of two antennas are set to a position P1(2,2,16) and a position P2(2,6,16) in a three-dimensional space (x,y,z) having the origin (0,0,0) at a predetermined corner of the base. The coordinates (x,y,z) showing the three-dimensional space are provided as relative coordinates, since the origin O is set in each model. Accordingly, the respective coordinate axes are shown by different symbols, such as (X1,Y1,Z1) and (X2,Y2,Z2) in FIGS. 4 and 5.

As shown in FIG. 3, the antenna information includes the power feed position, the polarization characteristic, the directional plane, the directional angle and the power feed point angle. The power feed position indicates the position (coordinates) of a power feed point to an antenna relative to the installation location (x,y,z) of the antenna as the origin when the center of the directional plane of the antenna is adjusted to the installation location of the antenna and the antenna is arranged at the power feed point angle. The polarization characteristic indicates whether a polarized wave is linearly polarized wave or a circularly polarized wave. When the polarized wave is a circularly polarized wave, information indicating “clockwise turning” or “counterclockwise turning” may further be stored. The directional angle means the angle of radiation having the intensity of radiation equal to or greater than a specified value. The power feed point angle means the angle of superposition of the directional plane at the power feed point. An omnidirectional antenna has the direction angle of 360 degrees. The power feed point angle indicates the angle of an antenna at the power feed position. This is because the orientation of an antenna is adjustable in x direction and in y direction about its installation location. For example, the antenna information with respect to the access point of the model number “A001” includes the power feed position “(x+0,y+1,z+4)”, the polarization characteristic “linearly”, the directional plane “x-y plane”, the direction angle “360 degrees” and the power feed point angle “90 degrees on Z axis”. When the two antennas are adjusted to the vertical direction (90 degrees on Z axis), one of the antennas at the installation location (2,2,16) has the power feed position (2,3,20).

The guide information includes the display position of each arrow image representing the directionality and the direction of polarization of an antenna and the direction of the arrow image. FIG. 5 is a diagram schematically illustrating the display positions in the guide information. As an example, FIG. 5 schematically illustrates the display positions in the guide information with respect to the access point of the model number “A001”. As shown in FIG. 3, the two antennas included in the access point of the model number “A001” have the same guide information. More specifically, the guide information includes the arrow position “4” and the directions of arrows “+X, −X, +Y, −Y” as shown in FIG. 3. Accordingly, positions P21, P22, P23 and P24 shifted by “4” in +X direction, in −X direction, in +Y direction and in −Y direction relative to a power feed point P11 (0,1,4) of a model M2 simulating an antenna are set as the display positions of arrow images as shown in FIG. 5. The respective values shown in FIG. 3 may be changed arbitrarily. For example, the arrow position may be set to “0” in the first record (No. 1 record). In this case, the four arrow images are arranged toward the four directions from the power feed point P11 as the starting point.

The template image database storage 20b shown in FIG. 2 has a template image database stored in advance. The template image database stores appearance images of various access points and stations in correlation to model numbers of the respective devices. The image storage 20c stores images taken by the imaging unit 50 and composite images created by the composite image creator 10c. The template image database may be stored in advance in the memory 20 as a database attached to the application for performing the antenna characteristic guide process or may be read from an external storage device such as an SD memory card as needed basis.

The router 200 described above is sometimes referred to herein as the wireless communication device. The antenna characteristic specifier 10b is sometimes referred to as the type identifier, the antenna characteristic information acquirer, the matching degree specifier and the antenna orientation specifier in the claims. The antenna characteristic information database storage 20a is sometimes referred to as the storage in the claims. The composite image creator 10c is sometimes referred to as the antenna characteristic image creator, the image composer and the matching degree notifier in the claims.

A2. Antenna Characteristic Guide Process

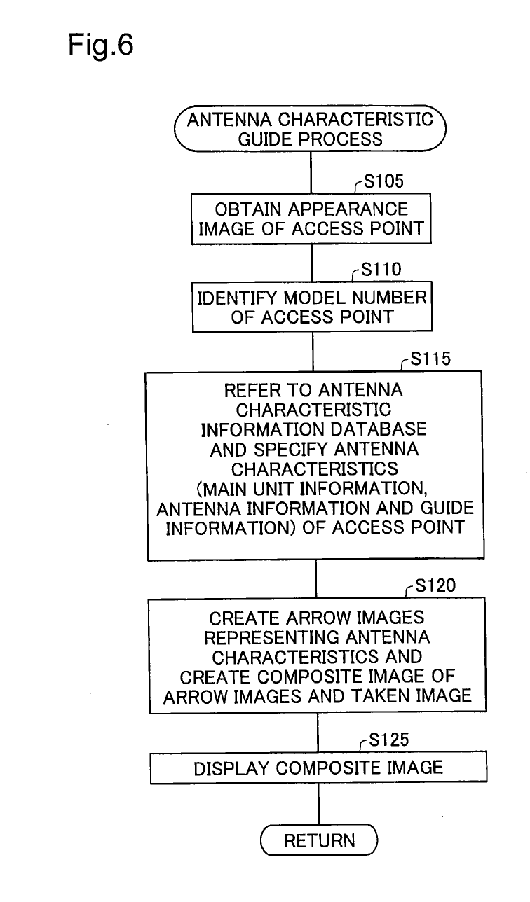

FIG. 6 is a flowchart showing the procedure of the antenna characteristic guide process according to the first embodiment. This antenna characteristic guide process may be preinstalled as the function of the mobile phone terminal 100 or may be installed afterwards in the mobile phone terminal 100 as an application to be executed. Alternatively the antenna characteristic guide process may be performed as an add-in program by the Web browser. This alternative may be implemented by any of various configurations: for example, a JAVA program may be read from a specified site to be executed.

According to this embodiment, a menu for starting the antenna characteristic guide process is provided in advance in the mobile phone terminal 100. When the user selects an antenna adjustment menu displayed on the display unit 30 in the mobile phone terminal 100, the CPU 10 performs a process of obtaining the appearance image of an access point (step S105). In this process (step S105), a message that requests the user to take an image of the access point is displayed on the display unit 30, and the mobile phone terminal 100 waits in this state until the user takes a shot. When the user points the mobile phone terminal 100 at the router 200 and presses the shutter button of the operation unit 70, the mobile phone terminal 100 performs an imaging process using the imaging controller 10a. The message requesting the user to take a shot may optionally include a message that indicates the imaging direction of the router 200 (for example, “Take a shot from the front”). Such option advantageously enhances the accuracy of pattern matching described below. The guide may be provided in the form of an audio message instead of or in addition to the visual message.

When the user presses the shutter button of the operation unit 70, the imaging controller 10a controls the imaging unit 50 to take an image of the access point (router 200), obtains the appearance image of the access point and stores the obtained appearance image in the image storage 20c (step S105). The antenna characteristic specifier 10b compares the image obtained at step S105 with the respective images of various access points stored in the template image database storage 20b and identifies the model number of the access point by pattern matching (step S110). An alternative procedure may specify a character string, such as model number, written on the enclosure from the obtained image and identify the model number from the specified character string. When the access point is unidentifiable from the taken image or the character string such as model number is unrecognizable, it is desirable to request the user to discard the taken image and take a shot again.

The antenna characteristic specifier 10b refers to the antenna characteristic information database based on the model number identified at step S110 and specifies the main unit information, the antenna information and the guide information with respect to the access point of the identified model number (step S115). When the model number “A001” is identified from the taken image of the router 200, the antenna characteristic specifier 10b retrieves the antenna characteristic information database shown in FIG. 3 and specifies the record in correlation to the identified model number, e.g., No. 1 record.

The composite image creator 10c creates arrow images representing the antenna characteristics based on the main unit information, the antenna information and the guide information specified at step S115, and then creates a composite image of the arrow images with the taken image obtained at step S105 (step S120). The display controller 10d causes the composite image created at step S120 to be displayed on the display unit 30 (step S125). After completion of step S125, the procedure returns to step S105 to wait until the user takes another shot. In this manner, still images including the antenna are repeatedly displayed on the display unit 30. When the user adjusts the direction of each antenna of the access point, a composite image including the appearance image of the antenna after the adjustment and the arrow images representing the antenna characteristics of the antenna after the adjustment is displayed on the display unit 30. This enables the user to visually check the latest antenna characteristics according to the latest direction of each antenna included in the access point from the display on the display unit 30.

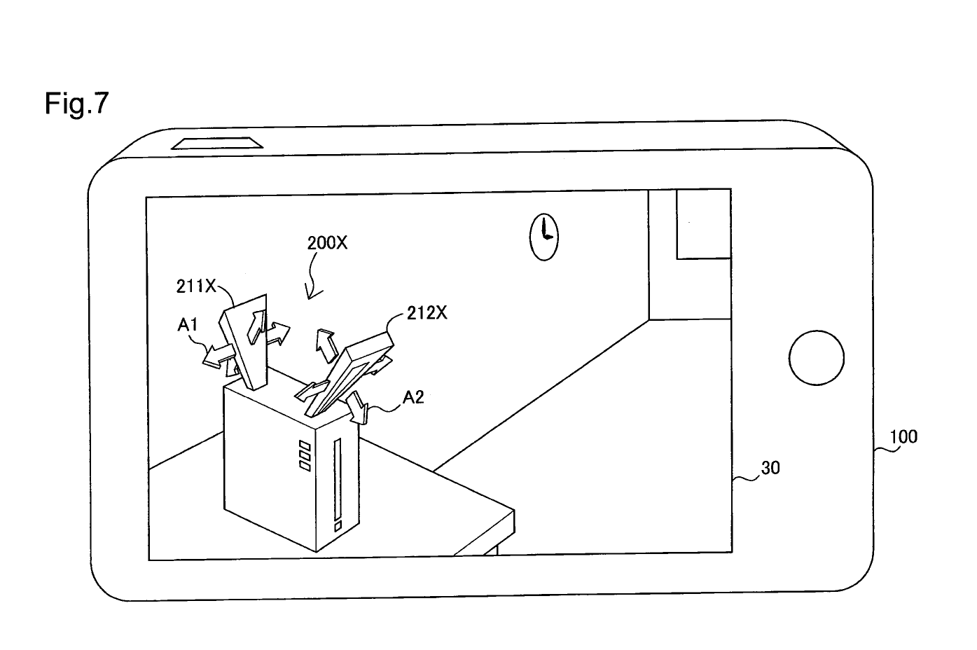

FIG. 7 is a diagram illustrating one example of the composite image displayed at step S125. As shown in FIG. 7, a composite image including an image 200X of the router 200 and arrow images representing the antenna characteristics are displayed on the display unit 30 of the mobile phone terminal 100. More specifically, arrow images A1 representing the direction of polarization and the directionality of the antenna 211 are displayed at a location near to an image 211X of the antenna 211 or more specifically at four points toward four different directions according to this embodiment. Similarly arrow images A2 representing the direction of polarization and the directionality of the antenna 212 are displayed at a location near to an image 212X of the antenna 212 or more specifically at four points toward four different directions. The user visually checks the composite image displayed on the display unit 30 and is then informed of the direction of polarization and the directionality of radio wave with respect to each of the two antennas 211 and 212. The user who is informed in advance of the direction of polarization and the directionality of radio wave with respect to the station 320 can thus adjust the orientation of at least one of the two antennas 211 and 212 to be matched to the direction of polarization and the directionality of radio wave with respect to the station 320. The arrow images A1 and A2 described above is sometimes referred to as the antenna characteristic image in the claims.

As described above, the mobile phone terminal 100 according to the first embodiment combines arrow images representing the antenna characteristics (directional angle and direction of polarization) of the two antennas 211 and 212 at the locations near to the respective two antennas 211 and 212 in the taken image of the router 200 and displays a resulting composite image on the display unit 30. This informs the user of how the orientations of the two antennas 211 and 212 are to be adjusted in order to be matched to the direction of polarization and the directionality of radio wave with respect to the station 320 and thereby enables the user to readily adjust the directions of the two antennas 211 and 212. According to this embodiment, the antenna characteristics are shown on the display unit 30 of the mobile phone terminal 100 by using the actually taken image of the router 200. This facilitates the user's understanding of the antenna characteristics based on the real machine, compared with a manual including photographs of the machine.

### B. Second Embodiment

B1. Device Configuration

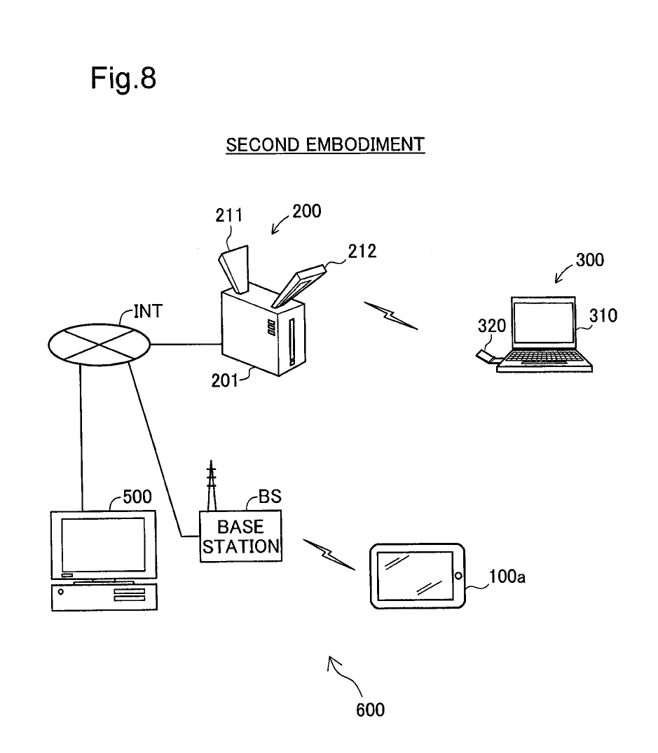

FIG. 8 is a diagram illustrating the schematic configuration of an antenna adjustment support system according to a second embodiment. The antenna adjustment support system 600 includes a mobile phone terminal 100a and a server 500. The server 500 is connected to the Internet INT. The mobile phone terminal 100a establishes wireless communication with a base station BS of a mobile communication network and transmits data to and from the server 500 via the mobile communication network and the Internet INT. Like the first embodiment, in the antenna adjustment support system 600 of the second embodiment, the antenna characteristics of the two antennas 211 and 212 of the access point (router 200) are displayed on the mobile phone terminal 100a. This enables the user to readily adjust the directions (orientations) of the two antennas 211 and 212, in order to improve the communication quality between the router 200 and the client 300. The router 200 and the client 300 of the second embodiment are identical with the router 200 and the client 300 of the first embodiment and are thus not specifically described here.

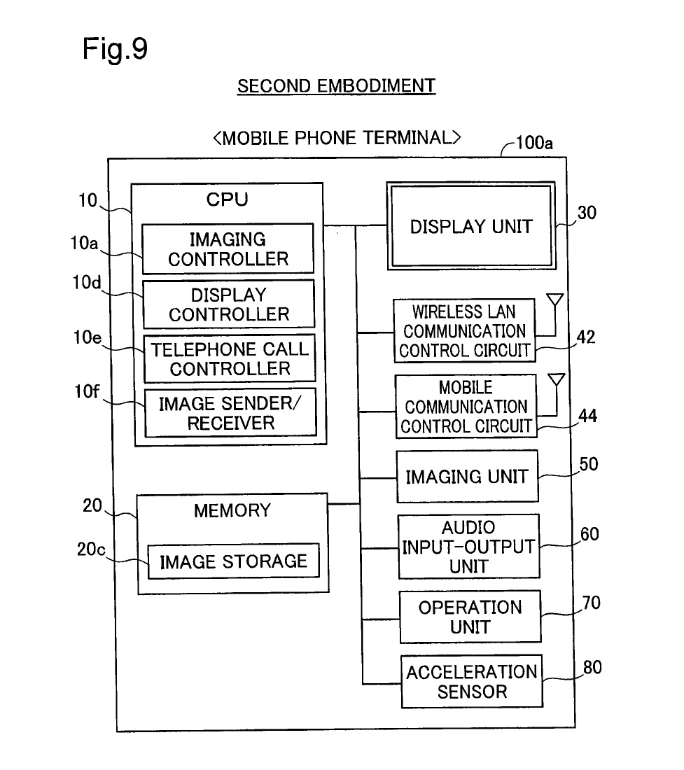

FIG. 9 is a block diagram illustrating the detailed structure of the mobile phone terminal 100a according to the second embodiment. The mobile phone terminal 100a differs from the mobile phone terminal 100 of the first embodiment by replacement of the antenna characteristic specifier 10b and the composite image creator 10c with an image sender/receiver 10f as the function of the CPU 10 and by exclusion of the antenna characteristic information database storage 20a and the template image database storage 20b from the memory 20, but the other structure is similar to that of the mobile phone terminal 100 of the first embodiment. The image sender/receiver 10f sends and receives images to and from the server 500.

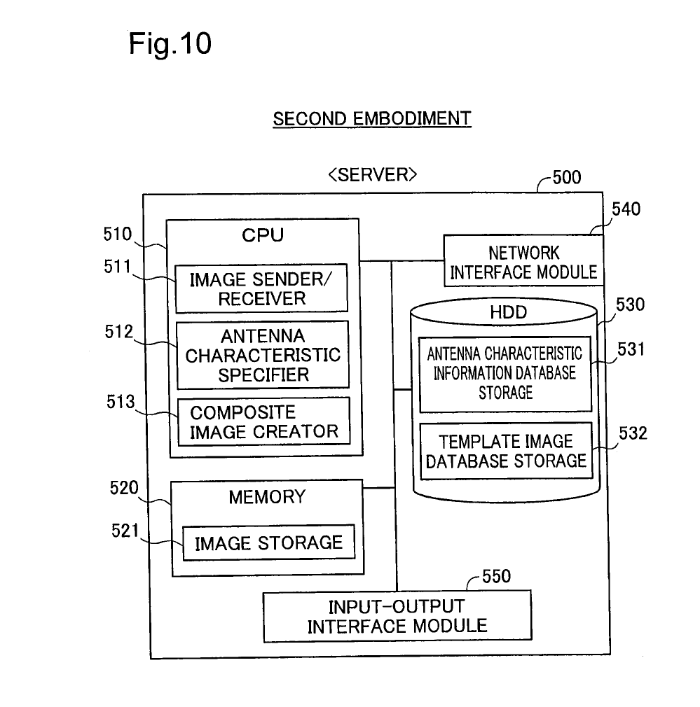

FIG. 10 is a block diagram illustrating the detailed structure of the server 500 shown in FIG. 8. The server 500 includes a CPU 510 a memory 520, a hard disk drive 530, a network interface module 540 and an input-output interface module 550. The CPU 510 executes a control program stored in the memory 520 to serve as an image sender/receiver 511, an antenna characteristic specifier 512 and a composite image creator 513. The image receiver/sender 511 sends and receives images to and from the mobile phone terminal 100a. The antenna characteristic specifier 512 is provided in the server 500 but has the same functions as those of the antenna characteristic specifier 10b of the first embodiment and is thus not specifically described here. Similarly the composite image creator 513 has the same functions as those of the composite image creator 10c of the first embodiment and is thus not specifically described here. The memory 520 includes an image storage 521. The image storage 521 stores images received from the mobile phone terminal 100a and composite images created in the server 500.

The hard disk drive 530 includes an antenna characteristic information database storage 531 and a template image database storage 532. The antenna characteristic information database storage 531 and the template image database storage 532 are provided in the server 500 but respectively have the same functions as those of the antenna characteristic information database storage 20a of the first embodiment and the template image database storage 20b of the first embodiment and are thus not specifically described here.

The network interface module 540 has an interface for connecting with a terminated device of an access line, such as ADSL modem. The input-output interface module 550 has an interface for connecting with peripheral devices (not shown), such as a display, a keyboard and a mouse.

The mobile phone terminal 100a described above is sometimes referred to herein as the first device. The server 500 is sometimes referred to herein as the second device. The image sender/receiver 10f and the image sender/receiver 511 respectively are sometimes referred to herein as the taken image sender and the composite image sender.

B2. Antenna Characteristic Guide Process

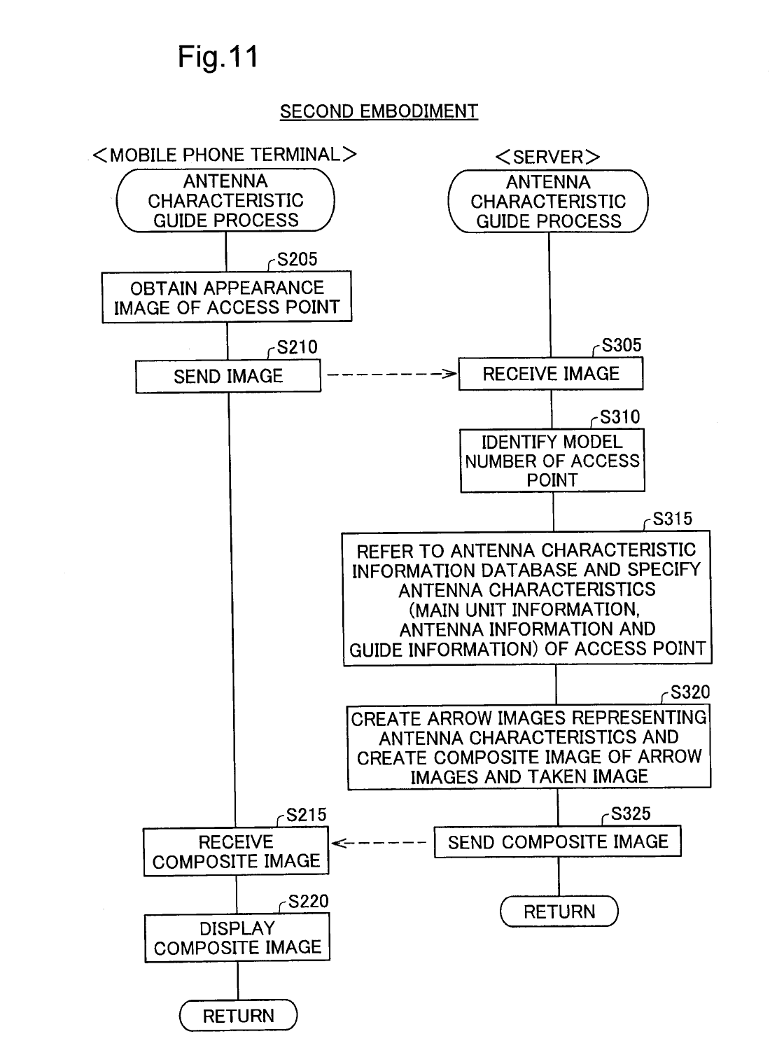

FIG. 11 is a sequence diagram showing the procedure of the antenna characteristic guide process according to the second embodiment. The left diagram of FIG. 11 is a flowchart showing the procedure in the mobile phone terminal 100a, and the right diagram of FIG. 11 is a flowchart showing the procedure in the server 500. Like the first embodiment, the antenna characteristic guide process of the second embodiment is triggered by the user's predetermined operation (e.g., selection of the antenna adjustment menu).

On the start of the antenna characteristic guide process, the mobile phone terminal 100a obtains the appearance image of an access point (step S205). This process requests the user to take an image of the access point (router 200) and waits for the user's pressing operation of the shutter button. In response to the user's press of the shutter button, the imaging controller 10a controls the imaging unit 50 to take an image of the access point, obtains the appearance image of the access point and stores the obtained image in the image storage 20c (step S205). Step S205 is the same as step S105 in the antenna characteristic guide process of the first embodiment. According to the second embodiment, the mobile phone terminal 100a or more specifically its image sender/receiver 10f sends the taken image obtained at step S205 to the server 500 via the mobile communication control circuit 44 (step S210).

The server 500 or more specifically its image sender/receiver 511 receives the taken image sent from the mobile phone terminal 100a and stores the received image in the image storage 521 (step S305). In the server 500, the antenna characteristic specifier 512 identifies the model number of the access point (step S310) and specifies the main unit information, the antenna information and the guide information (step S315), while the composite image creator 513 creates a composite image (step S320). These steps S310, S315 and S320 are the same as steps S110, S115 and S120 in the antenna characteristic guide process of the first embodiment and are thus not specifically described here. On completion of the above processing, the server 500 or more specifically its image sender/receiver 511 sends the composite image created at step S320 to the mobile phone terminal 100a (step S325).

The mobile phone terminal 100a waits for a response from the server 500 after transmission of the taken image and receives the composite image sent from the server 500 by its image sender/receiver 10f (step S215). The received composite image may be stored in the image storage 20c. The mobile phone terminal 100a or more specifically its display controller 10d causes the composite image created at step S320 to be displayed on the display unit 30 (step S220). Step S220 is the same as step S125 in the antenna characteristic guide process of the first embodiment.

The antenna adjustment support system 600 of the second embodiment described above has the similar advantageous effects to those of the mobile phone terminal 100 of the first embodiment. Additionally, since the server 500 has the antenna characteristic information database and the template image database and serves to specify the antenna characteristics of the access point and create a composite image, the configuration of the second embodiment advantageously reduces the memory capacity required for the mobile phone terminal 100a and reduces the processing load of the CPU 10. This effectively reduces the manufacturing cost of the mobile phone terminal 100a. The configuration of the second embodiment also enables the server 500 to collectively manage the antenna characteristic information and the template images of various models of devices and thereby facilitates management of product information, for example, processing for a new model.

### C. Third Embodiment

A mobile phone terminal 100 according to a third embodiment has the same hardware configuration as that of the first embodiment but differs from the mobile phone terminal 100 of the first embodiment by displaying the antenna characteristics of a station in addition to the antenna characteristics of an access point in the antenna characteristic guide process. The other structure is similar to that of the first embodiment.

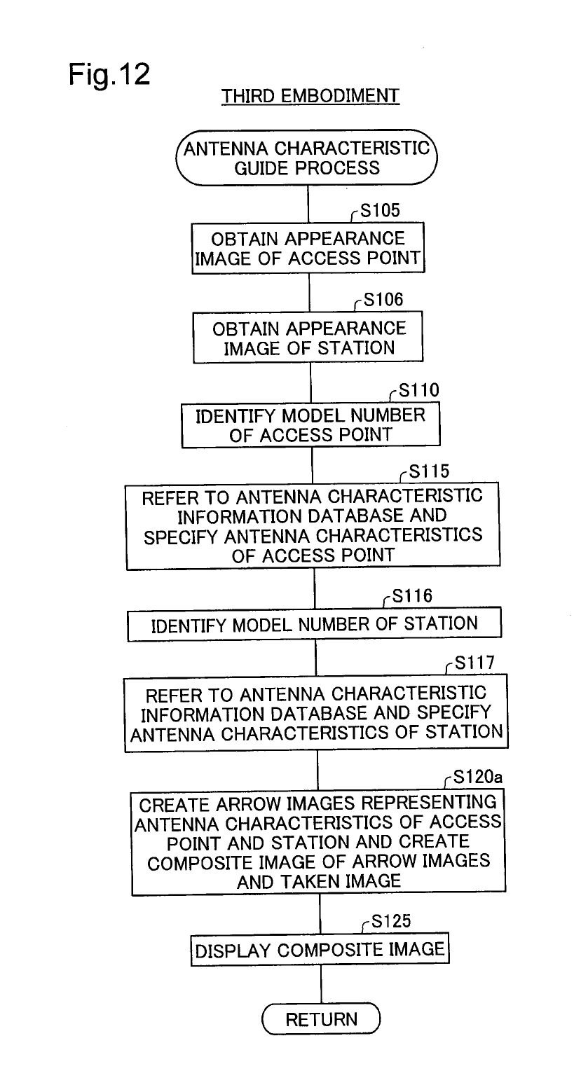

FIG. 12 is a flowchart showing the procedure of an antenna characteristic guide process according to the third embodiment. The antenna characteristic guide process of the third embodiment differs from the antenna characteristic guide process of the first embodiment by addition of steps S106, S116 and S117 and replacement of step S120 with step S120a, but is otherwise similar to the antenna characteristic guide process of the first embodiment.

After performing step S105 to obtain the image of the access point (router 200) in the same manner as the first embodiment, the mobile phone terminal 100 performs a process of obtaining the appearance image of a station (step S106). This process requests the user to take an image of the client 300 (station 320) using the mobile phone terminal 100 and waits until the user presses the shutter button. In response to the user's press of the shutter button, the imaging controller 10a controls the imaging unit 50 to take an image of the station 320, obtains the appearance image of the station and stores the obtained image in the image storage 20c (step S106). After step S105, a message requesting the user to take an image of the station 320, for example, “Next, take a shot of a station”, may be displayed on the display unit 30 or may be provided in the form of voice guide. The taken image of the mobile phone terminal 100 and the taken image of the station 320 according to this embodiment respectively are sometimes referred to as the first taken image and the second taken image in the claims, and the mobile phone terminal 100 and the station 320 are sometimes referred to as the wireless communication device in the claims.

After step S106, the processing of steps S110 and S115 described in the first embodiment is performed. After step S115, the antenna characteristic specifier 10b compares the image obtained at step S106 with the respective images of various stations stored in the template image database storage 20b and identifies the model number of the station by pattern matching (step S116). An alternative procedure may specify a character string, such as model number, written on the enclosure of the station from the obtained image and identify the model number from the specified character string.

The antenna characteristic specifier 10b refers to the antenna characteristic information database based on the model number identified at step S116 and specifies the main unit information, the antenna information and the guide information with respect to the station of the identified model number (step S117).

The composite image creator 10c creates arrow images representing the antenna characteristics of the access point (router 200) based on the main unit information, the antenna information and the guide information of the access point (router 200) specified at step S115, creates arrow images representing the antenna characteristics of the station (station 320) based on the main unit information, the antenna information and the guide information of the station (station 320) specified at step S117, and then creates a composite image of the respective arrow images with the taken image of the access point obtained at step S105 (step S120a). After creation of the composite image, the composite image is displayed on the display unit 30 at step S125.

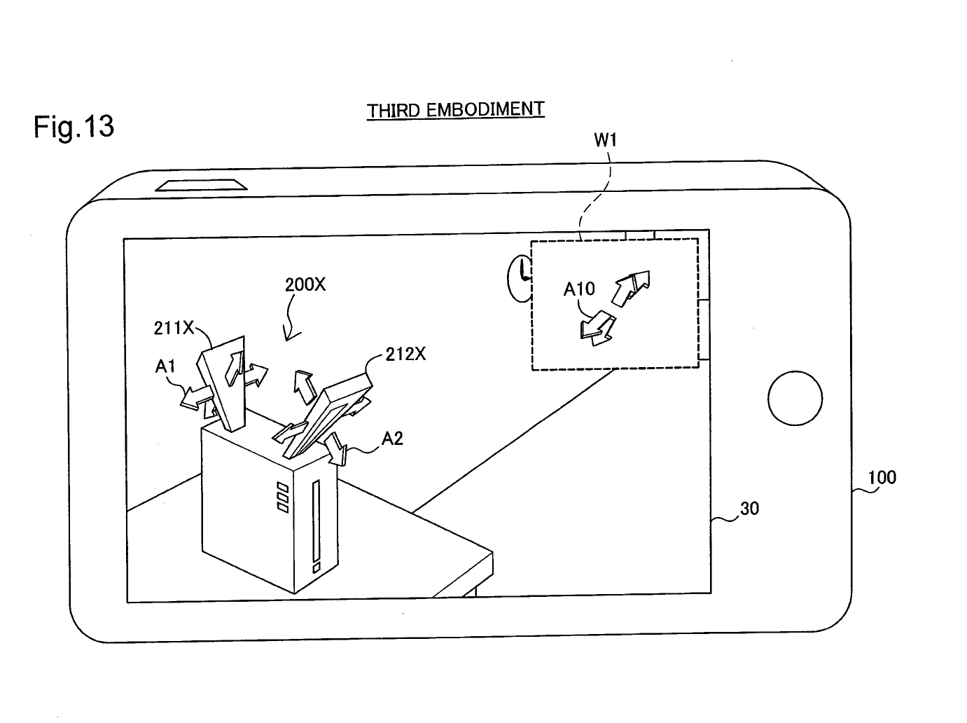

FIG. 13 is a diagram illustrating one example of the composite image displayed at step S125 according to the third embodiment. The composite image shown in FIG. 13 includes an image 200X of the router 200 and arrow images A1 and A2 representing the antenna characteristics of the two antennas 211 and 212, like FIG. 7. Additionally, a sub-window W1 is displayed at the upper right corner of the composite image shown in FIG. 13. Arrow images A10 representing the antenna characteristics of the station 320 are shown in the sub-window W1.

As shown in FIG. 13, the composite image does not include the image of the station 320. This means that the user has changed the direction of the mobile phone terminal 100 between imaging of the router 200 at step S105 and imaging of the station 320 at step S106. The change in direction of the mobile phone terminal 100 may be measured by the acceleration sensor 80 provided in the mobile phone terminal 100, and arrow images representing the antenna characteristics of the station 320 may be created by taking into account this change. More specifically, the process of step S120a may adjust the antenna characteristics of the station specified at step S117 (for example, directions of arrows) to compensate for the change in direction of the mobile phone terminal 100 and then create arrow images. This visualizes the antenna characteristics of the station 320, which is located at the position corresponding to the upper right corner of the composite image. The user can thus be informed accurately of the difference between the direction of polarization of the two antennas 211 and 212 included in the router 200 and the direction of polarization of the station 320.

The mobile phone terminal 100 of the third embodiment described above has the similar advantageous effects to those of the mobile phone terminal 100 of the first embodiment. Additionally, the mobile phone terminal 100 of the third embodiment displays the antenna characteristics of the antenna included in the station (station 320) together with the antenna characteristics of the antenna included in the access point (router 200) in the same image. The user can thus be readily informed of which direction the antenna of the access point or the antenna of the station is to be adjusted, in order to match the directions of polarization of these two antennas to each other. Furthermore, the antenna characteristics of the station are adjusted to compensate for the change in direction of the mobile phone terminal 100 between imaging of the access point and imaging of the station. The composite image can thus accurately indicate the difference between the direction of polarization of the antenna included in the access point and the direction of polarization of the antenna included in the station.

In the configuration of the third embodiment described above, the sub-window W1 is shown in the displayed image including the router 200, and the antenna characteristics of the station 320 are shown in this sub-window W1. Alternatively, a sub-window may be shown in a displayed image including the client 300 (station 320), and the antenna characteristics of the router 200 may be shown in this sub-window. The display in the sub-window may be only the arrow images representing the antenna characteristics but may additionally include the actually taken image of the station or the router. In this latter application, the image taken with the mobile phone terminal 100 may not be directly displayed without any processing but may be displayed with specific deformation corresponding to the change in direction of the mobile phone terminal 100 between imaging of the router and imaging of the station, in order to prevent the user from feeling strange. The model may be obtained by simulating the actually taken image as described in the first embodiment and may be deformed to readily represent the router or the station in the form corresponding to the change in direction of the mobile phone terminal 100.

### D. Fourth Embodiment

A mobile phone terminal 100 according to a fourth embodiment differs from the mobile phone terminal 100 of the third embodiment by displaying the difference between the direction of polarization of an antenna included in an access point and the direction of polarization of an antenna included in a station in a quantified manner in the antenna characteristic guide process. The other structure is similar to that of the mobile phone terminal 100 of the third embodiment.

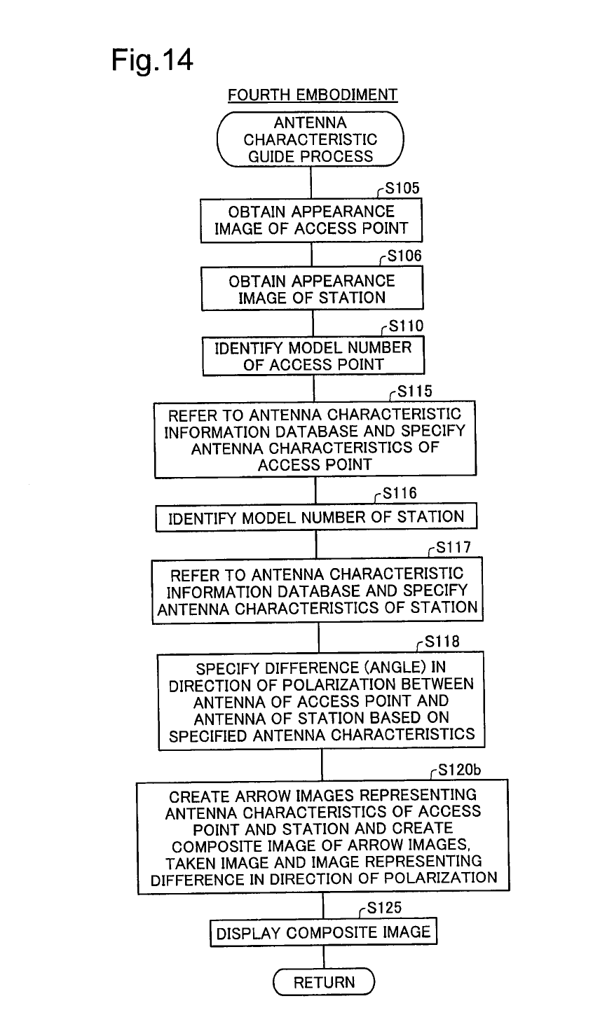

FIG. 14 is a flowchart showing the procedure of an antenna characteristic guide process according to the fourth embodiment. The antenna characteristic guide process of the fourth embodiment differs from the antenna characteristic guide process of the third embodiment shown in FIG. 12 by addition of step S118 and replacement of step S120a with step S120b, but is otherwise similar to the antenna characteristic guide process of the third embodiment.

After the processing of steps S105 to S117 described above, the antenna characteristic specifier 10b specifies the difference between the direction of polarization of the antenna included in the access point and the direction of polarization of the antenna included in the station, based on the antenna characteristics of the access point specified at step S115 and the antenna characteristics of the station specified at step S117 (step S118). Like the processing of step S120a described above in the third embodiment, the antenna characteristics of the antenna included in the station may be adjusted, to compensate for the change in direction of the mobile phone terminal 100 between imaging at step S105 and imaging at step S106.

After step S118, the composite image creator 10c creates arrow images representing the antenna characteristics of the antenna included in the access point and arrow images representing the antenna characteristics of the antenna included in the station and combines the respective arrow images, the taken image of the access point and an image representing the difference in direction of polarization specified at step S118 to create a composite image (step S120b). After creation of the composite image, the composite image is displayed on the display unit 30 at step S125 as described above.

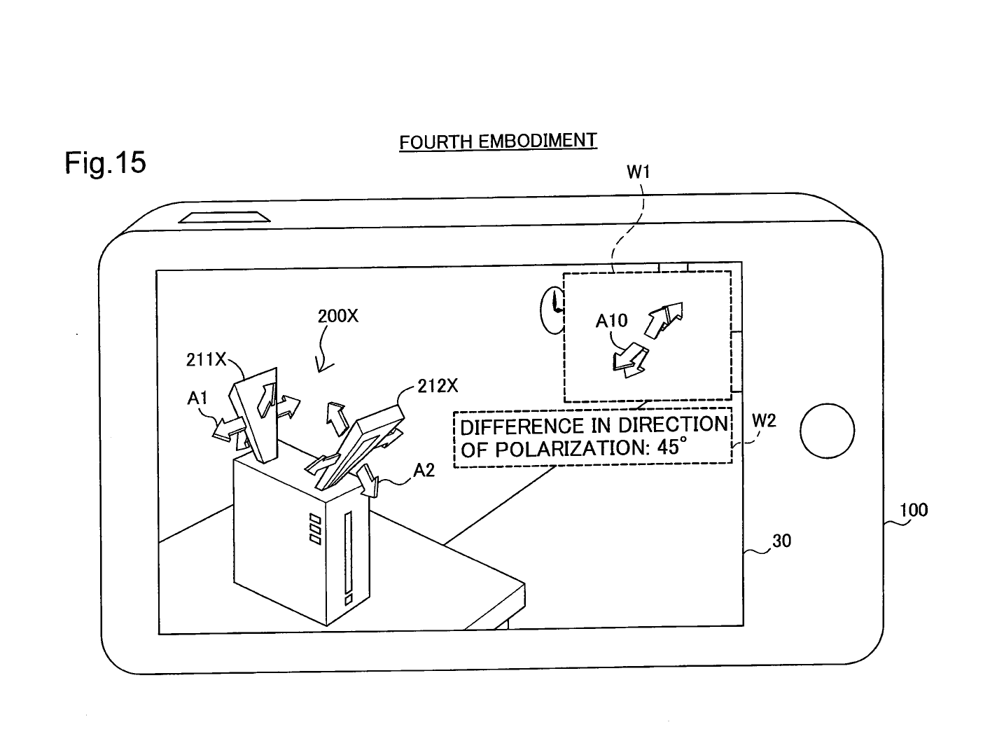

FIG. 15 is a diagram illustrating one example of the composite image displayed at step S125 according to the fourth embodiment. As shown in FIG. 15, a sub-window W2 is displayed below the sub-window W1. The difference in direction of polarization specified at step S118 is displayed in a quantified manner in the sub-window W2. The display of the difference (angle) in direction of polarization in the sub-window W2 accurately informs the user of the difference between the direction of polarization of the antenna included in the access point and the direction of polarization of the antenna included in the station. This enables the user to accurately adjust and match the direction of polarization of the antenna included in the access point to the direction of polarization of the antenna included in the station. In the display of FIG. 15, the coordinate axes (X1,Y1,Z1) shown in FIG. 4 may further be displayed in combination to additionally specify which axis and what direction the angle or the difference in direction of polarization indicates. Alternatively, only a rotational axis involved in the difference in direction of polarization may be displayed in the three-dimensional manner, and the difference in direction of polarization relative to the rotational axis may be illustrated in the form of a display representing rotation about the rotational axis alone or together with the numerical representation. The user is thus readily informed of which axis and what degree the difference in direction of polarization plane indicates.

The mobile phone terminal 100 of the fourth embodiment described above has the similar advantageous effects to those of the mobile phone terminal 100 of the third embodiment. Additionally, the mobile phone terminal 100 of the fourth embodiment displays the difference between the direction of polarization of the antenna included in the access point and the direction of polarization of the antenna included in the station in the quantified manner. This accurately informs the user of the difference in direction of polarization and also informs the user of the required degree of adjustment to match the direction of polarization of the antenna included in the access point to the direction of polarization of the antenna included in the station. Informing the user of the difference in direction of polarization, in other words, the matching degree of the direction of polarization, enables the user to readily check whether the direction of the antenna of the access point (router 200) or the direction of the antenna of the station (station 320) has been adjusted to the desired direction.

### E. Modifications

The disclosure is not limited to the above embodiments or examples but various modifications and variations may be made to the embodiments without departing from the scope of the disclosure. Some examples of possible modifications are given below.

### E1. Modification 1

The antenna characteristics of the antenna included in the access point and the antenna characteristics of the antenna included in the station are represented by the still arrow images in the above embodiments, but the disclosure is not limited to such representation.

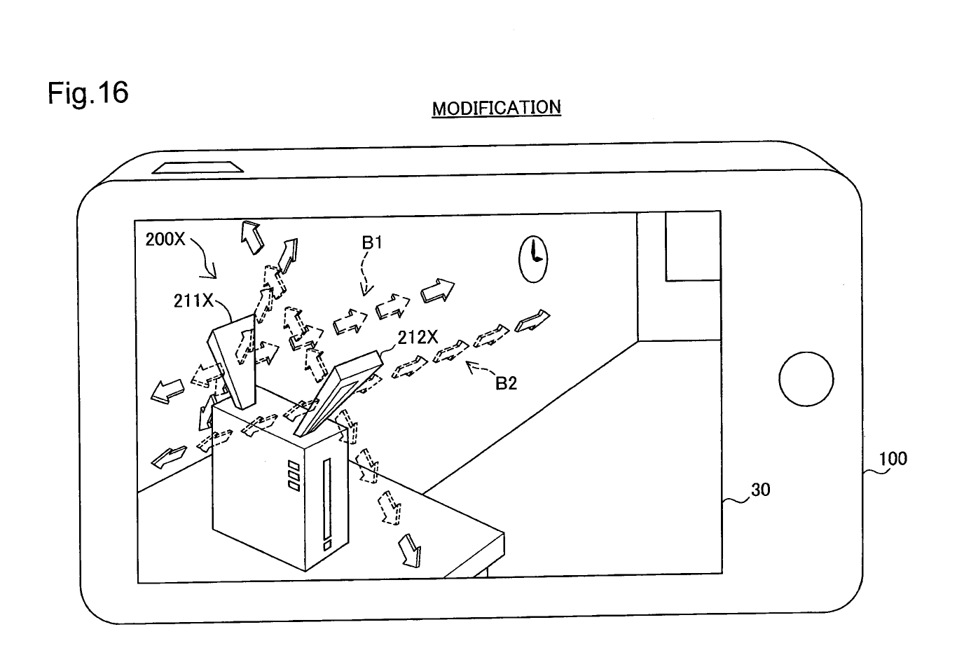

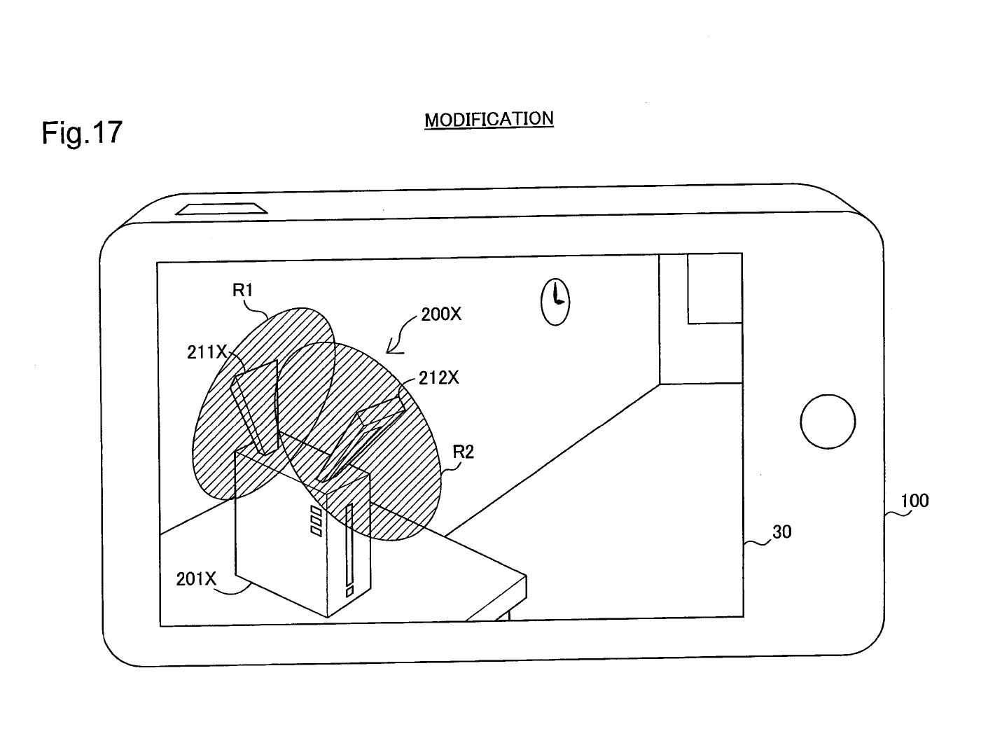

FIGS. 16 and 17 respectively illustrate examples of the composite image according to Modification 1. For example, as shown in FIG. 16, the antenna characteristics may be represented by moving arrow images (animation) B1 and B2 that respectively show the arrow moving along the direction of polarization. The moving image B1 corresponds to the animation of the arrow image A1 of FIG. 7 moving along the direction of the arrow. The moving image B2 corresponds to the animation of the arrow image A2 of FIG. 7 moving along the direction of the arrow. The display of this application facilitates the user's understanding on the antenna characteristics and the difference in direction of polarization. The user can thus readily check the states of the respective antennas and adjust the respective antennas.

In another example, as shown in FIG. 17, the polarization plane of each antenna may be represented by a circular image. More specifically, the polarization plane of the antenna 211 may be represented by a circular image R1, and the polarization plane of the antenna 212 may be represented by a circular image R2. The circular images R1 and R2 may be located about the power feed positions of the respective antennas 211 and 212. The display of this application has the similar advantageous effects to those of the above embodiments.

Although the image representing the antenna characteristics, e.g., arrow image or circular image, is displayed at the location near to the antenna in the respective embodiments and the modifications described above, the image may alternatively be displayed at a position distant from the antenna. In this alternative application, the image representing the antenna characteristics may be displayed in correlation to the taken image of the access point or the taken image of the station. Such display facilitates the user's understanding on whether each image representing the antenna characteristics indicates the antenna characteristics of the antenna included in the access point or the antenna characteristics of the antenna included in the station.

The configuration of the above embodiments takes a still image and displays the arrow images or the animation representing the antenna characteristics on the still image, but the disclosure is not limited to this configuration. For example, another configuration may take a moving image (video) and display the arrow images or the animation representing the antenna characteristics on the moving image. In general, any arbitrary configuration that takes either a still image or a moving image and displays an image representing the antenna characteristics on the taken image may be applied to the graphical user interface apparatus and the system of the disclosure. The image used for the graphical user interface may not be the actually taken image itself but may be a processed image obtained by image processing, such as binarization or contour enhancement, on the actually taken image. A computer graphic image created based on the actually taken image or a composite image of the computer graphic image and the actually taken image may also be used for the same purpose.

E2. Modification 2

The image combined with the image of the access point in the above embodiments is the image representing the antenna characteristics or the image representing the difference in direction of polarization, but the disclosure is not limited to such images. For example, an image representing the difference in directionality of radio wave may be combined with the image of the access point. In another example, an image representing the direction of adjustment of the antenna may be combined with the image of the access point.

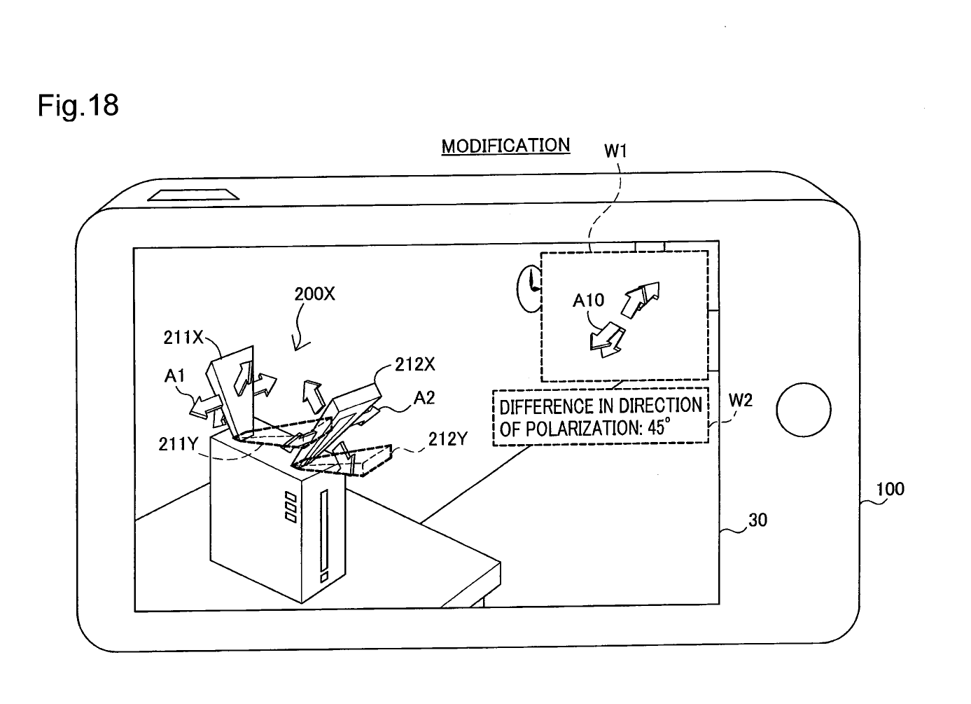

FIG. 18 is a diagram illustrating one example of the composite image according to Modification 2. The composite image shown in FIG. 18 differs from the composite image of the fourth embodiment shown in FIG. 15 by additional display of two images 211Y and 212Y representing the ideal positions of the respective antennas, but the other display details are identical with those of the composite image of the fourth embodiment shown in FIG. 15.

The image 211Y shown in FIG. 18 indicates the position of the antenna 211 when the direction of polarization of the antenna 211 is matched to the direction of polarization of the station 320. Similarly the image 212Y indicates the position of the antenna 212 when the direction of polarization of the antenna 212 is matched to the direction of polarization of the station 320. Such images 211Y and 212Y may be displayed, for example, by the following process. After specification of the difference between the direction of polarization of the antennas 211 and 212 included in the access point (router 200) and the direction of polarization of the antenna included in the station (station 320) at step S118 in the antenna characteristic guide process of the fourth embodiment, the antenna characteristic specifier 10b may specify the positions of the antennas 211 and 212 to compensate for the specified difference (hereinafter called “ideal positions”) and create images of the antenna 211 and 212 located at the respective ideal positions. The composite image created at step S120b may include such antenna images. According to one embodiment, a three-dimensional computer graphics model (3D-CG model) of an antenna located at a specified position may be stored in correlation to the appearance image of each access point in the template image database, and the image of the antenna located at the ideal position may be created by deforming this 3D-CG model to a shape located at the ideal position. Such modified configuration facilitates the user's understanding on the required adjustment of the position of the antenna included in the access point (router 200) to compensate for the difference in direction of polarization.

In addition to display of the ideal position, the state of moving from the current position to the ideal position may be displayed in the form of a moving image (animation). This provides the user with the accurate guide on adjustment of the antenna position and thus enables the user to adjust the antenna position to the ideal position in a short period of time.

### E3. Modification 3

The image representing the antenna characteristics or the image representing the difference in direction of polarization is combined with the taken image of the access point (router 200) in the above embodiments, but the disclosure is not limited to such composition. For example, an image representing the antenna characteristics or an image representing the difference in direction of polarization may be combined with the taken image of the station 320, in place of the taken image of the access point (router 200). Another modification may simultaneously take images of the access point (router 200) and the station 320 (client 300) and respectively combine images representing the antenna characteristics with the taken image of the router 200 and the taken image of the station 320. This latter modification enables the image of the access point (router 200), the image of the station (station 320) and the images representing the antenna characteristics to be displayed in one single image plane, so as to facilitate the user's understanding on the difference between the direction of polarization of the antenna included in the access point and the direction of polarization of the antenna included in the station.

An image representing the antenna characteristics or an image representing the difference in direction of polarization may also be combined with a taken image of any other wireless communication device that has an antenna and is connectable to a wireless LAN, in place of the taken image of the access point and the taken image of the station. For example, an image representing the antenna characteristics or an image representing the difference in direction of polarization may be combined with the taken image of a WDS (Wireless Distribution System) device. Such modified configuration facilitates the user's understanding on which direction an antenna of each WDS device is to be directed to, in order to improve the communication quality between two WDS devices.

### E4. Modification 4

Although the composite image is displayed on the display unit of the mobile phone terminal 100 or 100a in the above embodiments, the composite image may be displayed in another display device, instead of the mobile phone terminal 100 or 100a. For example, a digital TV receiver or a monitor of the client 300 may be employed as such a display device. In the configuration that displays the composite image on the digital TV receiver, the composite image may be sent from the mobile phone terminal 100 or 100a or the server 500 to the digital TV receiver to be displayed. For example, the composite image may be sent and received via a wired interface (e.g., USB (Universal Serial Bus) or HDMI (High-Definition Multimedia Interface)) that connects the mobile phone terminal 100 or 100a with the digital TV receiver. In another example, the digital TV receiver may be connected to a wireless LAN, and the composite image may be sent and received via the wireless LAN. The digital TV receiver or the monitor of the client 300 has the higher display resolution than the display unit 30 of the mobile phone terminal 100 or 100a and thereby enables the antenna characteristics or the difference in direction of polarization to be displayed in more user-friendly manner

### E5. Modification 5

Although the image of the access point or the image of the station is taken with the mobile phone terminal 100 or 100a in the above embodiments, another device may be used for imaging, in place of the mobile phone terminal 100 or 100a. For example, a digital still camera may be used for imaging. In this embodiment, image data obtained by imaging may be transferred from the digital still camera via a medium such as a memory card and stored in the image storage 20c of the mobile phone terminal 100 or 100a or may be transferred via a wireless LAN. Such configurations have the similar advantageous effects to those of the above embodiments.

### E6. Modification 6

In the second embodiment described above, the server 500 is connected to the Internet INT, and the mobile phone terminal 100a sends and receives data to and from the server 500 via the mobile communication network and the Internet INT. The disclosure is, however, not limited to this configuration. According to another configuration, the server 500 and the mobile phone terminal 100a may be connected to an identical wireless LAN, and data may be transmitted between the mobile phone terminal 100a and the sever 500 via the wireless LAN. This modified configuration enables high-speed communication between the mobile phone terminal 100a and the sever 500 and advantageously shortens the time required for the antenna characteristic guide process. Alternatively, the server 500 and the mobile phone terminal 100a may be interconnected by another technique, such as Bluetooth or wireless USB. According to this alternative configuration, the antenna characteristic information database and the template image database may be stored in an NAS (Network Attached Storage) in place of the server 500, and the NAS may be used to specify the antenna characteristics and create a composite image. This configuration allows omission of a server device and thereby enables the antenna adjustment support system to be constructed at low cost. According to yet another configuration, the antenna characteristic information database and the template image database may be stored in the server 500 or the NAS, and the sever 500 or the NAS may be used only for specification of the antenna characteristics. In the first embodiment described above, the antenna characteristic information database is stored in advance in the antenna characteristic information database storage 20a, and the template image database is stored in advance in the template image database storage 20b. The disclosure is, however, not limited to this configuration. For example, in the configuration that the antenna characteristic information database and the template image database are stored in the sever 500 or in the NAS, the mobile phone terminal 100 may download the antenna characteristic information and the template images from the server 500 or the NAS and store the downloaded antenna characteristic information and template images in the antenna characteristic information database storage 20a and in the template image database storage 20b in the antenna characteristic guide process.

### E7. Modification 7

The model number of the access point and the model number of the station are identified by pattern matching based on the taken images in the above embodiments, but the disclosure is not limited to this configuration. For example, the model numbers may be identified by the user's entry using the operation unit 70 and the display unit 30 of the mobile phone terminal 100 or 100a, instead of pattern matching. In another example, in the event of failed identification by pattern matching, the user may enter the model numbers by using the operation unit 70 and the display unit 30 of the mobile phone terminal 100 or 100a. Such configurations enable more accurate identification of the model numbers. Alternatively the model numbers may be identified by voice recognition using the telephone call controller 10e.

### E8. Modification 8

Although the antenna characteristics or the difference in direction of polarization is provided in the form of image guide in the above embodiments, audio or voice guide may be used in place of the image guide. In another example, the access point may use a display lamp, such as LED (Light Emitting Diode), to guide the direction of polarization or the difference in direction of polarization. Such configurations have the similar advantageous effects to those of the above embodiments.

### E9. Modification 9

The difference between the direction of polarization of the antenna included in the access point and the direction of polarization of the antenna included in the station is indicated by the angle in the fourth embodiment described above, but the difference may be indicated by the degree of difference instead of the angle. For example, the degree of difference may be quantified, where 0 indicates the state of no difference in direction of polarization (angle of difference is 0 degree) and 100 indicates the state of a difference of 180 degrees in direction of polarization. The degree of difference in direction of polarization may be replaced by the matching degree in direction of polarization. For example, the matching degree in direction of polarization may be quantified, where the matching degree of 100 in direction of polarization corresponds to the state of no difference in direction of polarization (angle of difference is 0 degree) and the matching degree of 0 in direction of polarization corresponds to the state of a difference of 180 degrees in direction of polarization.

### E10. Modification 10

The antenna characteristic guide process is performed to automatically specify a target device (antenna) having the antenna characteristics and display the antenna characteristics of the specified antenna in the above embodiments, but the disclosure is not limited to this configuration. For example, in the configuration that employs a touch panel for the display unit 30, the user may specify or identify an antenna by touching a corresponding antenna part in the taken image displayed on the display unit 30 to display the antenna characteristics of the specified or identified antenna.

### E11. Modification 11

The third embodiment displays the antenna characteristics of the station 320 with automatically cancelling the change (displacement) between the direction of the mobile phone terminal 100 at the time of imaging the router 200 and the direction of the mobile phone terminal 100 at the time of imaging the station 320. The disclosure is, however, not limited to this configuration. For example, after imaging the router 200, another configuration may display the direction (inclination) of the mobile phone terminal 100 to be directed for imaging the station 320 on the display unit 30 to be matched to the direction of the mobile phone terminal 100 directed for imaging the router 200. This configuration may specify the change from the direction of the mobile phone terminal 100 directed for imaging the router 200, for example, by the acceleration sensor 80 of the mobile phone terminal 100 and display the desired direction of the mobile phone terminal 100 to compensate for this specified change on the display unit 30.

### E12. Modification 12

In the respective embodiments, at least part of the software configuration may be replaced by hardware configuration. On the contrary, at least part of the hardware configuration may be replaced by software configuration.

### F. Other Embodiments

The disclosure may also be implemented according to any of other embodiments described below.

According to one embodiment of the graphical user interface apparatus, the antenna characteristic image may be displayed at a location near to the antenna in the taken image on the display unit, in order to indicate at least one of the directionality of radio wave and the direction of polarization. This configuration facilitates the user's understanding on the directionality of radio wave and the direction of polarization near to the antenna of the wireless communication device as the target device to be adjusted.

In the graphical user interface apparatus of the embodiment, the taken image may include at least one of a wireless LAN access point and a wireless LAN station as the wireless communication device. This configuration facilitates the understanding of the user of the wireless LAN access point or the wireless LAN station on the directionality of radio wave and the direction of polarization with respect to the target device to be adjusted. This configuration also facilitates adjustment of the directions of the antennas of these devices by the user.

The graphical user interface apparatus of the embodiment may further include: an imaging unit that obtains the taken image; a type identifier that identifies a type of the wireless communication device, based on the taken image; an antenna characteristic information acquirer that acquires antenna characteristic information regarding the antenna characteristic, based on the identified type; an antenna characteristic image creator that creates the antenna characteristic image, based on the obtained antenna characteristic information; and an image composer that combines the taken image with the antenna characteristic image and thereby create a composite image. The display controller may display the created composite image on the display unit. The graphical user interface apparatus of this configuration identifies the type of the wireless communication device based on the taken image, specifies the antenna characteristic information based on the identified type of the wireless communication device and creates the antenna characteristic image based on the specified antenna characteristic information, so that an image accurately indicating the antenna characteristic of the wireless communication device can be displayed on the display unit. The imaging unit may take an image of the wireless communication device itself or may take an image of a specific code attached to the wireless communication device or its accessory or manuals, in order to obtain the type of the wireless communication device. The specific code may be a barcode, a QR code or a model name.

In the graphical user interface apparatus of the embodiment, the taken image may include a wireless LAN access point and a wireless LAN station as the wireless communication device. The imaging unit may obtain a first taken image including the access point and a second taken image including the station. The type identifier may identify a type of the access point based on the first taken image and identifies a type of the station based on the second taken image. The antenna characteristic information acquirer may acquire the antenna characteristic information with respect to the access point and the antenna characteristic information with respect to the station. The antenna characteristic image creator may create the antenna characteristic image of the access point and the antenna characteristic image of the station. The image composer may create the composite image including the first taken image or the second taken image, the antenna characteristic image of the access point and the antenna characteristic image of the station expressed in one single image plane. This configuration enables the first taken image of the access point or the second taken image of the station, the antenna characteristic image of the access point and the antenna characteristic image of the station to be displayed in one single image plane on the display unit and thereby facilitates the understanding of the user of the access point or the user of the station on the desired adjustment technique of the antenna. The desired adjustment technique is not limited to the display or the description on how the antenna is to be adjusted to the more desirable state but also includes the display and the description on the actions to be avoided.

The graphical user interface apparatus of the embodiment may further include a matching degree specifier and a matching degree notifier. The taken image may include a wireless LAN access point and a wireless LAN station as the wireless communication device. The imaging unit may obtain a first taken image including the access point and a second taken image including the station. The type identifier may identify a type of the access point based on the first taken image and identifies a type of the station based on the second taken image. The antenna characteristic information acquirer may acuire the antenna characteristic information with respect to the access point and the antenna characteristic information with respect to the station. The matching degree specifier may specify at least one of a matching degree between direction of polarization of radio wave radiated from an antenna of the access point and direction of polarization of radio wave radiated from an antenna of the station and a matching degree between directionality of radio wave radiated from the antenna of the access point and directionality of radio wave radiated from the antenna of the station, based on the antenna characteristic information obtained with respect to the access point and the antenna characteristic information obtained with respect to the station. The matching degree notifier may notify of the specified matching degree. This configuration readily informs the user of the matching degree between the direction of polarization of radio wave radiated from the access point and the direction of polarization of radio wave radiated from the station or the matching degree between the directionality of radio wave radiated from the access point and the directionality of radio wave radiated from the station. The user can thus readily check whether the antenna of the access point or the antenna of the station is adjusted to the more desirable state. Informing the matching degree enables the user to readily check whether the direction of the antenna of the access point or the direction of the antenna of the station is adjusted to the desired state.

The graphical user interface apparatus of the embodiment may further include an antenna orientation specifier. The taken image may include a wireless LAN access point and a wireless LAN station as the wireless communication device. The imaging unit may obtain a first taken image including the access point and a second taken image including the station. The type identifier may identify a type of the access point based on the first taken image and identifies a type of the station based on the second taken image. The antenna characteristic information acquirer may acquire the antenna characteristic information with respect to the access point and the antenna characteristic information with respect to the station. The antenna orientation specifier may specify adjustment detail for orientation of an antenna of the access point or orientation of an antenna of the station to reduce at least one of a difference between direction of polarization of radio wave radiated from the antenna of the access point and direction of polarization of radio wave radiated from the antenna of the station and a difference between directionality of radio wave radiated from the antenna of the access point and directionality of radio wave radiated from the antenna of the station, based on the antenna characteristic information obtained with respect to the access point and the antenna characteristic information obtained with respect to the station. The image composer may combine the first taken image or the second taken image, the antenna characteristic image of the access point, the antenna characteristic image of the station and an image indicating the specified adjustment detail to create the composite image. The image displayed on the display unit according to this configuration indicates the adjustment detail for the orientation of the antenna of the access point or the orientation of the antenna of the station in order to reduce the difference between the direction of polarization of radio wave radiated from the antenna of the access point and the direction of polarization of radio wave radiated from the antenna of the station or the difference between the directionality of radio wave radiated from the antenna of the access point and the directionality of radio wave radiated from the antenna of the station. This configuration facilitates the user's understanding on how the orientation of the antenna of the access point or the orientation of the antenna of the station is to be adjusted to adjust the direction of the antenna of the access point or the direction of the antenna of the station to the more desirable state. The image indicating the adjustment detail is displayed on the display unit, so as to reduce the time required for adjustment of the direction of the antenna of the access point or the direction of the antenna of the station.

In the graphical user interface apparatus of the embodiment, the antenna characteristic image may include an arrow image representing at least one of the directionality of radio wave and the direction of polarization of radio wave. This configuration facilitates the user's understanding on the directionality of radio wave or the direction of polarization of radio wave.

The graphical user interface apparatus of the embodiment may further include a storage that stores antenna characteristic information in correlation to a type of each wireless communication device. The antenna characteristic information acquirer may read the antenna characteristic information from the storage based on the identified type, so as to acuire the antenna characteristic information. This configuration allows omission of a mechanism of accessing to another device to obtain the antenna characteristic information or a mechanism of mounting a storage medium from the graphical user interface apparatus, thus reducing the manufacturing cost of the graphical user interface apparatus.

What is claimed is:

1. A graphical user interface apparatus, comprising:
a display unit; and
a display controller configured to cause the display unit to display a taken image including a wireless communication device with an antenna, in correlation to an antenna characteristic image representing an antenna characteristic including at least one of a directionality of a radio wave radiated from the antenna and a direction of polarization of the radio wave radiated from the antenna.

2. The graphical user interface apparatus according to claim 1, wherein
the display controller causes the display unit to display the antenna characteristic image at a location near to the antenna in the taken image to indicate at least one of the directionality of the radio wave and the direction of polarization.

3. The graphical user interface apparatus according to claim 1, wherein
the taken image includes at least one of a wireless LAN access point and a wireless LAN station as the wireless communication device.

4. The graphical user interface apparatus according to claim 1, further comprising:
an imaging unit that obtains the taken image;
a type identifier that identifies a type of the wireless communication device, based on the taken image;
an antenna characteristic information acquirer that acquires antenna characteristic information regarding the antenna characteristic, based on the identified type;
an antenna characteristic image creator that creates the antenna characteristic image, based on the obtained antenna characteristic information; and
an image composer that combines the taken image with the antenna characteristic image and thereby create a composite image, wherein
the display controller displays the created composite image on the display unit.

5. The graphical user interface apparatus according to claim 4, wherein
the taken image includes a wireless LAN access point and a wireless LAN station as the wireless communication device,
the imaging unit obtains a first taken image including the access point and a second taken image including the station,
the type identifier identifies a type of the access point based on the first taken image and identifies a type of the station based on the second taken image,
the antenna characteristic information acquirer acquires the antenna characteristic information with respect to the access point and the antenna characteristic information with respect to the station,
the antenna characteristic image creator creates the antenna characteristic image of the access point and the antenna characteristic image of the station, and
the image composer creates the composite image including the first taken image or the second taken image, the antenna characteristic image of the access point and the antenna characteristic image of the station expressed in one single image plane.

6. The graphical user interface apparatus according to claim 4, further comprising:
a matching degree specifier; and
a matching degree notifier, wherein
the taken image includes a wireless LAN access point and a wireless LAN station as the wireless communication device,
the imaging unit obtains a first taken image including the access point and a second taken image including the station,
the type identifier identifies a type of the access point based on the first taken image and identifies a type of the station based on the second taken image,
the antenna characteristic information acquirer acquires the antenna characteristic information with respect to the access point and the antenna characteristic information with respect to the station,
the matching degree specifier specifies at least one of a matching degree between direction of polarization of a radio wave radiated from an antenna of the access point and a direction of polarization of radio wave radiated from an antenna of the station and a matching degree between directionality of the radio wave radiated from the antenna of the access point and the directionality of radio wave radiated from the antenna of the station, based on the antenna characteristic information obtained with respect to the access point and the antenna characteristic information obtained with respect to the station, and
the matching degree notifier notifies of the specified matching degree.

7. The graphical user interface apparatus according to claim 4, further comprising:
an antenna orientation specifier, wherein
the taken image includes a wireless LAN access point and a wireless LAN station as the wireless communication device,
the imaging unit obtains a first taken image including the access point and a second taken image including the station,
the type identifier identifies a type of the access point based on the first taken image and identifies a type of the station based on the second taken image,
the antenna characteristic information acquirer acquires the antenna characteristic information with respect to the access point and the antenna characteristic information with respect to the station,
the antenna orientation specifier specifies adjustment detail for orientation of an antenna of the access point or orientation of an antenna of the station to reduce at least one of a difference between direction of polarization of radio wave radiated from the antenna of the access point and direction of polarization of radio wave radiated from the antenna of the station and a difference between directionality of radio wave radiated from the antenna of the access point and directionality of radio wave radiated from the antenna of the station, based on the antenna characteristic information obtained with respect to the access point and the antenna characteristic information obtained with respect to the station, and
the image composer combines the first taken image or the second taken image, the antenna characteristic image of the access point, the antenna characteristic image of the station and an image indicating the specified adjustment detail to create the composite image.

8. The graphical user interface apparatus according to claim 1, wherein
the antenna characteristic image includes an arrow image representing at least one of the directionality of radio wave and the direction of polarization of radio wave.

9. The graphical user interface apparatus according to claims 4, further comprising:
a storage that stores antenna characteristic information in correlation to a type of each wireless communication device, wherein
the antenna characteristic information acquirer reads the antenna characteristic information from the storage based on the identified type, so as to acquire the antenna characteristic information.

10. A system comprising:
a first device; and
a second device connected with the first device via a network and being arranged to support adjustment of direction of an antenna included in a wireless communication device, wherein
the first device including
an imaging unit that obtains a taken image including the wireless communication device,
a taken image sender that sends the taken image to the second device, and
a display unit that displays an image received from the second device, and
the second device including
a type identifier that identifies a type of the wireless communication device, based on the taken image received from the first device,
an antenna characteristic information acquirer that acquires antenna characteristic information regarding an antenna characteristic including at least one of a directionality of the radio wave radiated from the antenna and a direction of polarization of the radio wave radiated from the antenna, based on the identified type,
an antenna characteristic image creator that creates an antenna characteristic image representing the antenna characteristic, based on the obtained antenna characteristic information,
an image composer that combines the taken image with the antenna characteristic image and thereby create a composite image, and
a composite image sender that sends the composite image to the first device.

11. A method of supporting adjustment of direction of an antenna included in a wireless communication device by using a graphical user interface apparatus with a display unit, the method comprising:
obtaining a taken image including the wireless communication device in the graphical user interface apparatus; and
displaying on the display unit an antenna characteristic image representing an antenna characteristic including at least one of a directionality of a radio wave radiated from the antenna and a direction of polarization of the radio wave radiated from the antenna, in correlation to the taken image.

12. A method of supporting adjustment of direction of an antenna included in a wireless communication device by using a system that includes a first device with a display unit and a second device connected with the first device via a network, the method comprising:
obtaining a taken image including the wireless communication device in the first device;
sending the taken image from the first device to the second device;
identifying a type of the wireless communication device in the second device, based on the taken image received from the first device;
acquiring antenna characteristic information regarding an antenna characteristic including at least one of a directionality of a radio wave radiated from the antenna and a direction of polarization of the radio wave radiated from the antenna in the second device, based on the identified type;
creating an antenna characteristic image representing the antenna characteristic in the second device, based on the obtained antenna characteristic information;
combining the taken image with the antenna characteristic image to create a composite image in the second device;
sending the created composite image from the second device to the first device; and
displaying the composite image received from the second device on the display unit in the first device.

13. A non-transitory computer readable storage medium having computer readable instructions stored therein that when executed by a processing circuit performs a method of supporting adjustment of direction of an antenna included in a wireless communication device by using a graphical user interface apparatus with a display unit, wherein the method comprising;
obtaining a taken image including the wireless communication device in the graphical user interface apparatus; and
displaying an antenna characteristic image representing an antenna characteristic including at least one of directionality of radio wave radiated from the antenna and direction of polarization of radio wave radiated from the antenna, in correlation to the taken image, on the display unit.
